(19) United States
(12) Patent Application Publication
(10) Pub. No.: US 2018/0019776 A1
(43) Pub. Date: Jan. 18, 2018

(54) ELECTRONIC COMMUNICATION DEVICE WITH DETACHABLE WIRELESS MODULE AND METHOD THEREOF

(71) Applicant: Wang Han YAP, Tampin (MY)

(72) Inventor: Wang Han YAP, Tampin (MY)

(21) Appl. No.: 15/542,390

(22) PCT Filed: Jul. 1, 2016
(86) PCT No.: PCT/MY2016/050002

§ 371 Date: Jul. 7, 2017

(30) Foreign Application Priority Data
Jan. 9, 2015 (MY) PI2015700092

(51) Int. Cl. H04R 1/10; H04B 5/06

(52) U.S. Cl. CPC H04B 1/385; H04R 1/10; H04B 5/06; H04B 2001/3855; H04B 2001/3861

(57) ABSTRACT

The present invention is directed to an electronic communication device including a smart device adapted to be configured or worn around a wrist of user through a wrist-band, characterized in that the electronic communication device includes: a) at least one detachable wireless module detachably connected with the electronic communication device, b) a recess or housing adapted to receive or accommodate the detachable wireless module; wherein the detachable wireless module includes an engaging portion adapted to be detachably mounted to a complementary engaging member of the recess or housing; and wherein the detachable wireless module is adapted to be configured to operate in hands-tire operating mode and attaching operating mode; such that in the hands-free operating mode, the detachable wireless module is disengaged from the electronic communication device without the loss of Bluetooth paring or wireless interface connection; and in the attaching operating mode, the detachable wireless module becomes an integral part of the electronic communication device.

### FIELD OF INVENTION

The present invention relates to an electronic communication device, and more particularly to an electronic communication device with detachable wireless module and method thereof.

### BACKGROUND OF INVENTION

Mobile devices are becoming more useful to human users because of extended battery life, the additional benefits and features that are provided with the actual mobile devices and the various external accessories that interface with the devices. There has been a proliferation of wireless mobile communication devices in recent years in the field of telecommunications. Devices such as cordless and cellular telephones, pagers, wireless modems, wireless email devices, personal digital assistants (PDAs) with communication functions, and other mobile communication devices are becoming commonplace.

Known communication devices, however, are typically single-element or single-module designs. In order to enable hands-free operation of such single-module communication devices, specialized additional equipment or accessory is typically required. For example, a wired headset is often available for known communication devices that typically connect to the communication device through an electrical jack or plug. Another common hands-free accessory available for cellular or smart telephones is a docking cradle, which is typically intending for mounting the communication device in a vehicle.

Various prior-art methods attempt to provide solutions to the current issues and problems of the market available communication devices. One well-known type of communication device is the combination of watch and smart phone, commonly known as phone watch, which enables the user to be carried wherever they may travel. The advantageous to have such a companion device is that such apparatus or device is integrally built into wrist watch providing an interface to the smart phones or other mobile devices for frequently used operations. However, a common problem with the portability of this device is that they are required to be provided with integral mouth and ear pieces. Even when the ear piece and mouthpiece are provided at the extreme ends of the device, or the mouthpiece is provided as part of a flap which is unfolded for use, the size of the phone is determined by the requirement to have the mouthpiece and ear piece spaced apart in a manner that the device can be comfortably used.

In view of these and other shortcomings, it is advantageous to provide a detachable wireless module for electronic communication device in an effective and simplistic manner. Particularly, the present invention provides a detachable Bluetooth module for phone watch which is user-friendly, ergonomic, stylish and more comfortable to use, and yet without any loss of paring or wireless connection. However, a detachable device may be lost or damaged if not handled mindfully. A detachable device may also be inadvertently misplaced, resulting in wasted time in locating the device. It would therefore advantageous to find a way to allow a user to conveniently safe keep the detachable device after use.

The detachable wireless module for electronic communication device and its combination of elements, parts and method thereof will be exemplified in the detailed description.

### SUMMARY OF THE INVENTION

The present invention provides an electronic communication device with detachable wireless module. The electronic communication device includes a smart device adapted to be configured or worn around a wrist of user through a wrist-band, characterized in that the electronic communication device includes: a) at least one detachable wireless module detachably connected with the electronic communication device, wherein the detachable wireless module is a Bluetooth module or other short-range wireless interfaces with communication interface; b) a recess or housing adapted to receive or accommodate the detachable wireless module; wherein the detachable wireless module includes an engaging portion adapted to be detachably mounted to a complementary engaging member of the recess or housing; and wherein the detachable wireless module is adapted to be configured to operate in hands-free operating mode and attaching operating mode; such that in the hands-free operating mode, the detachable wireless module is disengaged from the electronic communication device without the loss of Bluetooth paring or wireless interface connection; and in the attaching operating mode, the detachable wireless module becomes an integral part of the electronic communication device when the said detachable wireless module is securely mounted to the recess or housing of the electronic communication device. The recess or housing (30) is located on front surface of the electronic communication device (20) or wrist band (24) so that the detachable wireless module can be conveniently handled by both right-handed and left-handed users.

In accordance with an embodiment of the present invention, the detachable wireless module includes a body provided with an engaging portion, said body further defines a limb extended therefrom serving as a supporting member. The detachable wireless module may be further provided with a gripping portion adapted to be configured along contour of outer surface of the body to facilitate comfortable and/or effective grasp by the user's fingers.

The recess or housing of the electronic communication device is provided with a complementary engaging member adapted to be matingly engaged with the engaging portion of the detachable wireless module. The recess or housing is further provided with resilient terminal adapted for providing electrical contact or interface with a conductive element of the detachable wireless module.

The resilient terminal has spring effect and when in contact with the conductive element of the detachable wireless module, enables the detachable wireless module to be recharged, or for any data transfer between the detachable wireless module and the electronic communication device in an attaching operating mode. The recess or housing of the electronic communication device may also serve as a storage compartment, or as being a battery charging compartment for the detachable wireless module.

By way of example but not limitation, the detachable wireless module is an ear-piece including headphone or headset; or mouth-piece including microphone or speaker; or in combination thereof. The detachable wireless module may also be of any other hands-free accessory adapted to be wired or wirelessly communicated or paired with a corresponding host of the electronic communication device.

Preferably, the smart device may be, but not limited to, a phone watch, smart watch, or intelligent watch or any other electronic devices, including smart phone, cordless or wireless mobile broadband, multimedia player, Global Positioning System (GPS) navigator, health monitoring device, wireless email device, or personal digital assistant (PDA) with communication functions adapted to be configured or worn around a wrist of the user, or any other type of wrist-band mobile electronic devices.

It will be appreciated that both hands-free operating and attaching operating modes of the detachable wireless module enables a communication between the user and the network conducted through the Bluetooth paring or wireless interface connection with the electronic communication device, either by short-range transceivers or long-range transceiver.

The present invention also provides a method for securing a detachable wireless module onto an electronic communication device. The method includes: a) inserting a body of a detachable wireless module such that a conductive element of the detachable wireless module makes contact with a resilient terminal in a recess or housing of the electronic communication device; b) pivotally shifting the body of the detachable wireless module about the resilient terminal when a user applies an urging force on the body of the detachable wireless module to perform a “slide-to-dip” action, enabling the engaging portion of the detachable wireless module to be securely engaged with the complementary engaging member in the recess or housing. When the urging force on the body is released, the resilient terminal urges on the detachable wireless module, thereby allowing the detachable wireless module to be securely attached onto the electronic communication device; and wherein the detachable wireless module is matingly fitted within the recess or housing of the electronic communication device, as soon as the “slide-to-clip” action is accomplished by the release of urging force on the body.

The detachable wireless module is may be a Bluetooth module or other short-range wireless interfaces with communication interface.

The electronic communication device includes a smart device adapted to be configured or worn around a wrist of user through a wrist-band.

The detachable wireless module is adapted to be configured to operate in hands-free operating mode and attaching operating mode. Accordingly, the detachable wireless module is capable of being disengaged from the electronic communication device without the loss of Bluetooth paring or wireless interface connection in the hands-free operating mode. The detachable wireless module may become an integral part of the electronic communication device when it is securely mounted to the recess or housing of the electronic communication device in the attaching operating mode.

In the preferred exemplary of the present invention, the resilient terminal enables the detachable wireless module to be recharged, or for any data transfer in between the detachable wireless module and the electronic communication device in an attaching operating mode. It will be appreciated that the recess or housing of the electronic communication device may serve as a storage compartment, or as being a battery charging compartment for the detachable wireless module.

By way of example but not limitation, detachable wireless module (10) is an ear-piece including headphone or headset; or mouth-piece including microphone or speaker; or in combination thereof. The detachable wireless module (10) may also be any other hands-free accessory adapted to be wired or wirelessly communicated or paired with a corresponding host of the electronic communication device.

Preferably, but not limiting to, the smart device is a phone watch, smart watch, or intelligent watch or any other electronic devices, including smart phone, cordless or wireless mobile broadband, multimedia player, Global Positioning System (GPS) navigator, health monitoring unit, wireless email device, or personal digital assistant (PDA) with communications functions adapted to be configured or worn around a wrist of the user, or any other types of wrist-band mobile electronic devices.

It will be appreciated that both hands-free operating and attaching operating modes of the detachable wireless module enables the communication between the user and the network conducted through the Bluetooth paring or wireless interface connection with the electronic communication device, either by short-range transceivers or long-range transceiver.

The present invention consists of several novel features and a combination of parts hereinafter fully described and illustrated in the accompanying description and drawings, it being understood that various changes in the details may be made without departing from the scope of the invention or sacrificing any of the advantages of the present invention.

### BRIEF DESCRIPTION OF THE DRAWINGS

The present invention will be fully understood from the detailed description given herein below and the accompanying drawings which are given by way of illustration only, and thus are not limitative of the present invention, wherein:

FIG. 1a is a perspective view illustrating an electronic communication device with a detachable wireless module, and more particularly to a detachable Bluetooth module being detached from a phone watch in accordance with a preferred example of present invention;

FIG. 1b is a perspective view of the electronic communication device with the detachable wireless module being shown attached from the electronic communication in accordance with a preferred example of present invention;

FIG. 2 illustrates the electronic communication device with the detachable wireless module attached thereon according to a preferred example of the present invention.

FIG. 3 is a perspective view of the detachable wireless module.

### DETAILED DESCRIPTION OF THE PREFERRED EMBODIMENTS

The present invention relates to an electronic communication device with a detachable wireless module. Hereinafter, this specification will describe the present invention according to the preferred examples of the present invention. However, it is to be understood that limiting the description on the preferred examples of the invention is merely to facilitate discussion of the present invention and it is envisioned that those skilled in the art may devise various modifications and equivalents without departing from the scope of the appended claims.

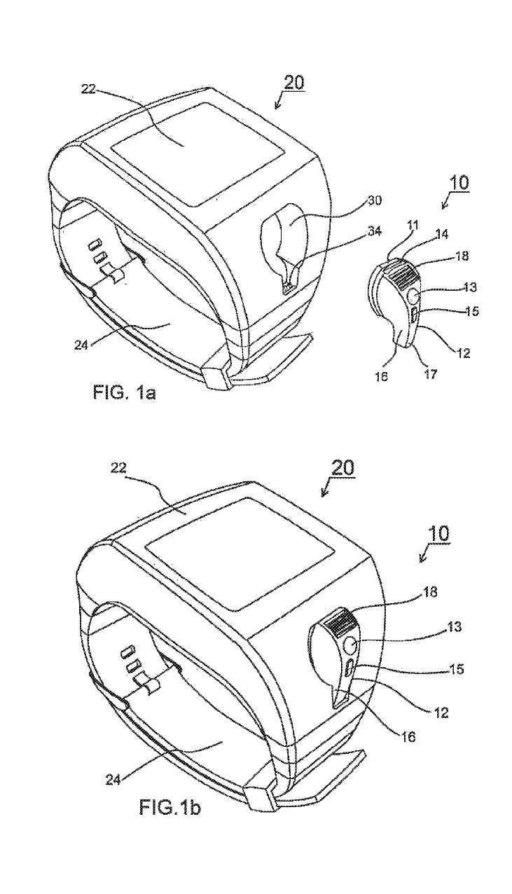

The electronic communication device (20) with a detachable wireless module (10) according to the preferred example of the present invention will now be described in accordance to the accompanying drawings FIGS. 1a to 3, either individually or in any combination thereof.

The detachable wireless module (10) generally includes a body (12) with an engaging portion (14) at its upper portion. The engaging portion (14) is defined by a first ridge (37) and a second ridge (38). Said body (12) includes a limb (16), extended therefrom and adapted to serve as supporting member, a volume adjustment knob (13), an on-off switch (15), a microphone (17) and a speaker (19). If desired, the detachable wireless module (10) may be further provided with a gripping portion (18) adapted to be configured along contour of outer surface of the body (12) to facilitate comfortable and/or effective grasp by the user's fingers.

By way of example but not limitation, the detachable wireless module (10) may be a Bluetooth module or other short-range wireless interfaces, which has a communication interface integrally or detachably connected with the electronic communication device (20). Said detachable wireless module (10) becomes a part of the electronic communication device (20) on being attached to the electronic communication device (20). By way of example but not by the way of limitation, the detachable wireless module (10) may be an ear-piece such as headphone or headset; or mouth-piece such as microphone or speaker; or in combination thereof. Said detachable wireless module (10) may also be any other hands-free accessory adapted to be wired or wirelessly communicated or paired with a corresponding host of the electronic communication device (20).

The electronic communication device (20) generally includes a smart device (22) adapted to be configured or worn around a wrist of the user through a wrist-band (24). By way of example but not limitation, the smart device (22) may be a phone watch, smart watch, or intelligent watch or any other electronic devices, such as smart phone, cordless or wireless mobile broadband, multimedia player, Global Positioning System (GPS) navigator, health monitoring unit, wireless email device, or personal digital assistant (PDA) with communications functions that is adapted to be configured or worn around a wrist of the user, or any other types of wrist-band mobile electronic devices.

Preferably, the electronic communication device (20) of the present invention is provided with a recess or housing (30) adapted to receive or accommodate the detachable wireless module (10). The recess or housing (30) of the electronic communication device (20) is preferably provided with, for example, but not limiting to, a complementary engaging member (32) adapted to be matingly engaged with the engaging portion (14) of the detachable wireless module (10). The recess or housing (30) may further be provided with a resilient terminal (34) adapted for providing electrical contact or interface to a conductive element (35) at the end of the limb (16) of the detachable wireless module (10). The resilient terminal (34) enables the detachable wireless module (10) to be recharged, or for any data transfer in between the detachable wireless module (10) and the electronic communication device (20) in an attaching operating mode. The recess or housing (30) of the electronic communication device (20) may serve as a storage compartment, or being a battery charging compartment for the detachable wireless module (10).

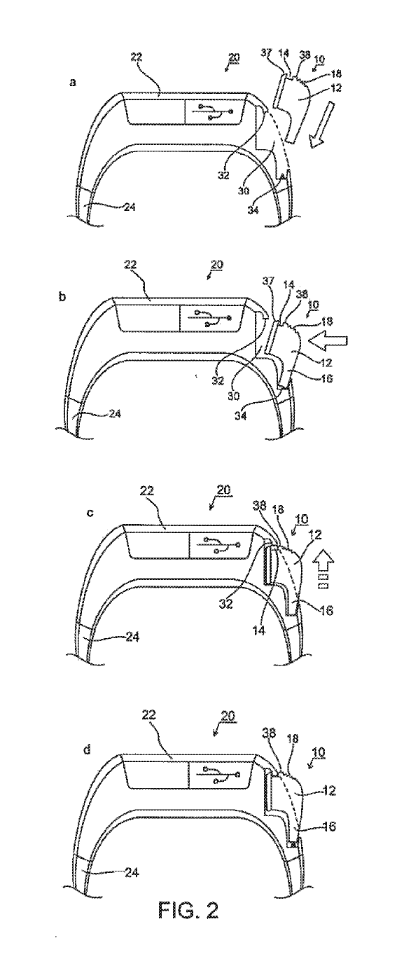

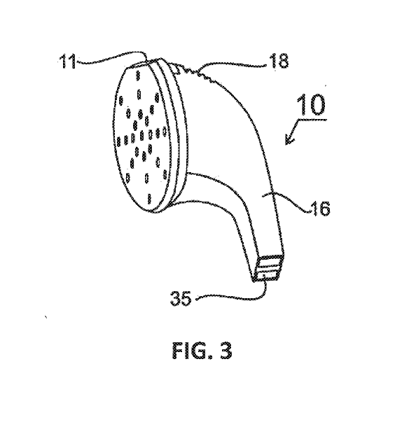

When a user wishes to securely mount the detachable wireless module (10) onto the electronic communication device (20), the limb (16) of the detachable wireless module (10) is first inserted into the recess or housing (30), such that the conductive element (35, FIG. 3) of the detachable wireless module (10) makes contact with the resilient terminal (34) of the recess or housing (30) (refer to FIGS. 2a and 2b). It will be appreciated that the resilient terminal (34) permits some degree of movement, so that the body (12) of the detachable wireless module (10) may be pivotally shifted about the resilient terminal (34) when an urging force is applied on the body (12) of the detachable wireless module (10) to perform a “slide-to-dip” action. When the engaging portion (14) of the detachable wireless module (10) is securely engaged with the complementary engaging member (32) on the recess or housing (30) (refer to FIGS. 2b and 2c), the user may then release the urging force on the body (12). The resilient terminal (34) then urges on the detachable wireless module (10), thereby securely attaching the detachable wireless module (10) onto the electronic communication device (20) (refer to FIG. 2d). Preferably the first ridge (37) defining the engaging portion (14) has a bevelled edge (11) to facilitate the engagement of the engaging portion (11) and the complementary engaging member (32). Further, when the detachable wireless module (10) and the electronic communication device (20) are engaged together (refer to FIG. 2d), the detachable wireless module (10) is matingly fitted within the recess or housing (30) of the electronic communication device (20). The recess or housing (30) is located on front surface of the electronic communication device (20) or wrist band (24) so that the detachable wireless module can be conveniently handled by both right-handed and left-handed users.

It will be appreciated that the detachable wireless module (10) and the electronic communication device (20), although used as an example herein in describing the configuration and method thereof of the preferred examples; however other suitable configurations, designs or methods may also contemplate. As such, the configuration of the detachable wireless module (10) and the electronic communication device (20), and its method thereof as mentioned herein should not be construed as limiting in any way.

By way of example but not limitation, the detachable wireless module (10) of the present invention may be configured to operate in two modes; a hands-free operating mode and an attaching operating mode. In the hands-free operating mode, the detachable wireless module (10) may be separated from the electronic communication device (20). Accordingly, in this mode, the detachable wireless module (10) is disengaged from the electronic communication device (20) to enable hands-free operating mode without the loss of Bluetooth paring or wireless interface connection.

In the attaching operating mode, the detachable wireless module (10) may be securely mounted onto the electronic communication device (20). Particularly, in this mode, the detachable wireless module (10) may become an integral part of the electronic communication device (20) when the detachable wireless module (10) is securely mounted to the recess or housing (30) of the electronic communication device (20).

It will be appreciated that both the hands-free operating and the attaching operating modes of the detachable wireless module (10) enables the communication between the user and the network to be conducted through the Bluetooth paring or wireless interface connection with the electronic communication device (20), either by short-range transceivers or long-range transceiver (if desired).

It should be noted that configurations of various mechanical parts, components, elements and/or methods used in carrying out the above-mentioned embodiments are illustrative and exemplary only. One of ordinary skill in the art would recognize that those configurations, mechanical parts, components elements and/or methods used herein may be altered in a manner so as to obtain different effects or desired operating characteristics. As such, the approached as described above should not be construed as limiting, but as the best mode contemplated by the inventor for carrying out the invention.

The invention being thus described, it will be obvious that the same may be varied in many ways. Such variations are not to be regarded as a departure from the principle and scope of the invention, and all such modifications as would obvious to one skilled in the art intended to be included within the scope of following claims.

1. An electronic communication device (20) adapted to be configured or worn around a wrist of user through a wrist-band (24), the electronic communication device (20) includes a smart device (22), characterized in that the electronic communication device (20) includes:
a) at least one detachable wireless module (10) detachably attached onto the electronic communication device (20), wherein the detachable wireless module (10) is a Bluetooth module or other short-range wireless interfaces with a communication interface; and
b) a recess or housing (30) adapted to receive or accommodate the detachable wireless module (10), wherein the recess or housing (30) is located on a front surface of the electronic communication device (20) or wrist band (24) and is provided with a resilient terminal (34) adapted for providing electrical contact or interface with a conductive element (35) of the detachable wireless module (10) to enable the recess or housing (30) to serve as both a storage and battery charging compartment for the detachable wireless module (10);
wherein the detachable wireless module (10) includes an engaging portion (14) adapted to be detachably engage able with a complementary engaging member (32) in the recess or housing (30);
wherein the resilient terminal (34) urges on the detachable wireless module (10) when the detachable wireless module (10) is housed in the recess or housing (30), thereby allowing the detachable wireless module to be securely attached onto the electronic communication device; and
wherein the detachable wireless module (10) is adapted to be configured to operate in hands-free operating mode and attaching operating mode; such that in the hands-free operating mode, the detachable wireless module (10) is disengaged from the electronic communication device (20) without the loss of Bluetooth paring or wireless interface connection; and in the attaching operating mode, the detachable wireless module (10) becomes an integral part of the electronic communication device (20) when the said detachable wireless module (10) is securely mounted to the recess or housing (30) of the electronic communication device (20).

2. The electronic communication device according to claim 1, wherein the contact between the resilient terminal (34) and the conductive element (35) enables the detachable wireless module (10) to be recharged, or for data transfer between the detachable wireless module (10) and the electronic communication device (20) in an attaching operating mode.

3. The electronic communication device according to claim 1, wherein the detachable wireless module (10) is an ear-piece, a mouth-piece, or a combination thereof.

4. The electronic communication device according to claim 1, wherein the detachable wireless module (10) can be hands-free accessory adapted to be wired or wirelessly communicated or paired with a corresponding host of the electronic communication device (20).

5. The electronic communication device according to claim 1, wherein the smart device (22) is a phone watch, smart watch, intelligent watch, smart phone, cordless or wireless mobile broadband device, multimedia player, Global Positioning System (GPS) navigator, health monitoring unit, wireless email device, or personal digital assistant (PDA) with communications functions adapted to be configured or worn around a wrist of the user.

6. The electronic communication device according to claim 1, wherein both hands-free operating and attaching operating modes of the detachable wireless module (10) enables the communication between the user and a network conducted through the Bluetooth paring or wireless interface connection with the electronic communication device (20), either by short-range transceivers or long-range transceivers.

7. A method for securing a detachable wireless module onto an electronic communication device, the method comprising:
a) inserting a body (12) of a detachable wireless module (10) such that a conductive element (35) on the body (12) makes contact with a resilient terminal (34) on a recess or housing (30) of the electronic communication device (20); and
b) pivotally shifting the body (12) of the detachable wireless module (10) about the resilient terminal (34) by applying an urging force on the body (12) of the detachable wireless module (10) to perform a “slide-to-clip” action;
wherein when the engaging portion (14) of the detachable wireless module (10) engages with the complementary engaging member (32) on the recess or housing (30), the resilient terminal urges on the detachable wireless module once the urging force on the body (12) is released, thereby securing holding the detachable wireless module (10) in the recess of housing (30) of the electronic communication device (20); and
wherein the detachable wireless module (10) is matingly fitted within the recess or housing (30) of the electronic communication device (20) when engaged together.

8. The method according to claim 7, wherein the electronic communication device (20) includes a smart device (22) adapted to be configured or worn around a wrist of a user through a wrist-band (24).

9. The method according to claim 8, wherein the smart device (22) is a phone watch, smart watch, intelligent watch, smart phone, cordless or wireless mobile broadband device, multimedia player, Global Positioning System (GPS) navigator, health monitoring unit, wireless email device, or personal digital assistant (PDA) with communications functions adapted to be configured or worn around a wrist of the user.

10. The method according to claim 7, wherein the detachable wireless module (10) is adapted to be configured to operate in hands-free operating mode and attaching operating mode.

11. The method according to claim 10, wherein the both hands-free operating and attaching operating modes of the detachable wireless module (10) enables the communication between the user and a network conducted through the Bluetooth paring or wireless interface connection with the electronic communication device (20), either by short-range transceivers or long-range transceivers.

12. The method according to claim 7, wherein the detachable wireless module (10) is a Bluetooth module or other short-range wireless interfaces with a communication interface.

13. The method according to claim 12, wherein the detachable wireless module (10) is disengaged from the electronic communication device (20) without the loss of Bluetooth paring or wireless interface connection in the hands-free operating mode.

14. The method according to claim 7, wherein the detachable wireless module (10) becomes an integral part of the electronic communication device (20) when it is securely mounted to the recess or housing (30) of the electronic communication device (20) in the attaching operating mode.

15. The method according to claim 7, wherein the resilient terminal (34) enables the detachable wireless module (10) to be recharged, or for data transfer between the detachable wireless module (10) and the electronic communication device (20) in an attaching operating mode.

16. The method according to claim 7, wherein the recess or housing (30) of the electronic communication device (20) serves as a storage compartment and/or a battery charging compartment for the detachable wireless module (10).

17. The method according to claim 7, wherein the detachable wireless module (10) is an ear-piece, a mouth-piece, or a combination thereof.

18. The method according to claim 7, wherein the detachable wireless module (10) can be hands-free accessory adapted to be wired or wirelessly communicated or paired with a corresponding host of the electronic communication device (20).

19. The electronic communication device according to claim 3, wherein the ear-piece is a headphone or headset and the mouth-piece is microphone or speaker.

20. The method according to claim 17, wherein the ear-piece is a headphone or headset and the mouth-piece is microphone or speaker.
